(19) United States
(12) Patent Application Publication
(10) Pub. No.: US 2016/0081327 A1
(43) Pub. Date: Mar. 24, 2016

(54) ORGAN AND TISSUE PRESERVATION SOLUTIONS HAVING INCREASED OXYGEN-CONTENT, STABILITY AND SHELF LIFE

(71) Applicant: SOMAHLUTION, LLC, Jupiter, FL (US)

(72) Inventors: Satish Menon, Jupiter, FL (US); Mahendra Suryan, Wellington, FL (US)

(21) Appl. No.: 14/786,556

(22) PCT Filed: Apr. 22, 2014
(86) PCT No.: PCT/US2014/034927

§ 371 Date: Oct. 23, 2015

Related U.S. Application Data
(60) Provisional application No. 61/854,448, filed on Apr. 24, 2013.

(51) Int. Cl. A01N 1/02

(52) U.S. Cl. CPC A01N 1/0226

(57) ABSTRACT

Organ and tissue preservation solutions having improved formulations are comprised of two separate solutions. The first solution includes one or more salts, water, dissolved oxygen, lactobionic acid, mannitol, glutamic acid and histidine at a pH of at least 7, preferably from about 7.3 to about 8.3. The second solution includes water and reduced glutathione at a pH of below 7.0, preferably from about 3 to 6 wherein oxygen present in the solution is removed. The two formulations are mixed together at the point of use resulting in an organ and tissue preservation solution having improved stability and that contains oxygen to prevent ischemia in the preserved organs. The present invention also includes kits that contain the two formulations.

The teachings of all of the references cited herein are incorporated in their entirety herein by reference.

### BACKGROUND OF THE INVENTION

U.S. Pat. No. 5,498,427 (hereinafter the '427 patent), the disclosure of which is incorporated herein by reference), discloses formulations for preserving organs and tissues, especially the preservation of the heart. CELESIOR® is a commercial embodiment having the following formulation:
Mannitol—60 mmol
Lactobionic Acid—80 mmol
Glutamtic Acid—20 mmol
Histidine—30 mmol
Calcium Chloride—0.25 mmol
Potassium Chloride—15 mmol
Magnesium Chloride—13 mmol
Sodium Hydroxide—100 mmol
Reduced Glutathione—3 mmol
Water for Injection—Up to 1 liter

However, the disclosed solutions have limited stability and shelf-life due to instability of the formulation. To address this instability, solutions of the '427 patent have been purged with nitrogen gas to remove dissolved oxygen from the solutions. However, the removal of the oxygen from the solution results in the solution being ischemic, thus depriving organs stored in the solutions of the '427 patent of oxygen.

Thus, there is a need to produce improved formulations of the '427 patent that are not ischemic, that contain oxygen in solution but which are at the same time stable and have a long shelf-life.

### SUMMARY OF THE INVENTION

The present invention fills this need by providing novel formulations of solutions disclosed in the '427 patent. The improved solutions are comprised of two formulations, a first solution, comprised of an aqueous solution, saturated with oxygen having a pH of 7.0 or above, preferably a pH from 7.3 to 8, and contains components that are stable in solution at a pH of 7.0 or above; and a second solution, aqueous solution in which oxygen has been substantially removed and having a pH of below 7.0, preferably a pH of 3-6, containing components which are more stable at a lower pH. The two solutions, the higher pH formulation and the lower pH formulation, are then mixed together at the point of use to resulting in the organ and tissue preservation solution having improved stability. The stability of the organ and tissue preservation solution is thus improved from weeks to many months.

If the pH of Solution A is 8.0 the pH of Solution B will be about 3.0. If the pH of Solution A is 7.8 the pH of Solution B will be about 4.0. And, if the pH of Solution A is 7.6 the pH of Solution B will be about 5.0.

In one embodiment of the present invention, the first solution contains one or more salts, water, and one or more of mannitol, lactobionic acid, glutamtic acid and histidine, at a pH of 7.0 or above, preferable a pH of from about 7.3 to 8. Further, the first solution is saturated with oxygen. The second solution is comprised of water, and reduced glutathione at a pH below 7, preferably a pH of from about 3 to 6; and the oxygen is been substantially removed from the solution. Dissolved oxygen can be removed from the second solution by purging the second solution with an inert gas such as nitrogen or argon. Generally, this means that there is insufficient oxygen present to have a deleterious effect on the glutathione. Ideally, this will be less than about 0.1 ppm. If the pH of Solution A is 8.0 the pH of Solution B will be about 3.0. If the pH of Solution A is 7.8 the pH of Solution B will be about 4.0. And, if the pH of Solution A is 7.6 the pH of Solution B will be about 5.0.

In a second embodiment of the present invention, the first solution contains one or more salts, water, mannitol, lactobionic acid, glutamtic acid and histidine, a pH of at least 7, preferably from about 7.3 to 8 and the solution contains dissolved oxygen, preferably saturated with oxygen. The second solution, Formulation B is comprised of water, reduced glutathione, mannitol, and histidine at a pH of from 3-6 and the oxygen has been substantially removed. If the pH of Solution A is 8.0 the pH of Solution B will be about 3.0. If the pH of Solution A is 7.8 the pH of Solution B will be about 4.0. And, if the pH of Solution A is 7.6 the pH of Solution B will be about 5.0.

### BRIEF DESCRIPTION OF THE DRAWINGS

FIG. 1 is a diagrammatic depiction of the present invention; and

FIG. 2 is a diagrammatic depiction of an alternative embodiment of the present invention.

### DETAILED DESCRIPTION

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described. For purposes of the present invention, the following terms are defined below.

As used herein, the term “patient” includes members of the animal kingdom including but not limited to human beings.

As employed herein, “organ” includes, but is not limited to, the heart, veins, arteries, lungs, liver, pancreas and the kidneys. Portions of organs are also contemplated.

As used herein, “sterile water” includes, but is not limited to, (a) sterile water for injection, USP, (b) sterile distilled deionized water, and (c) sterile water for irrigation.

As used herein, “cardioplegia” includes, but is not limited to, paralysis of the heart.

As used herein, “moderate hypothermia” is about 10.degree.-21.degree. C.

As used herein, an “antioxidant” is a substance that, when present in a mixture or structure containing an oxidizable substrate biological molecule, delays or prevents oxidation of the substrate biological molecule. For example, ascorbic acid is an antioxidant.

“Balanced salt solution” is defined as an aqueous solution that is osmotically balanced to prevent acute cell or tissue damage.

“Buffered salt solution” is defined as a balanced salt solution to which chemicals have been added to maintain a predetermined physiological pH range.

“Graft” is defined as tissue that is transplanted or implanted in a part of the body to repair a defect.

“Harvested bypass conduit” is defined as a surgically installed alternate route for the blood to bypass an obstruction.

“Solution of cardioplegia” is defined as a solution that aids in the preservation of the heart during transport or surgery.

“Cellular reducing agent” is defined as a substance that loses electrons easily thereby causing other substances to be reduced chemically.

“Physiological solution” is defined as an aqueous salt solution which is compatible with normal tissue, by virtue of being isotonic with normal interstitial fluid.

According to the present invention, an organ and tissue preservation system is formed by forming two separate solutions which can then be combined at the point of use to form an organ and tissue preservation solution. The system will include a first and second solution. The first solution contains components that are stable at a higher pH and with a higher concentration of dissolved oxygen. In particular, the first solution will include, in addition water, one or more of mannitol; lactobionic acid; glutamtic acid and histidine, as well as one or more salts, such as magnesium chloride; hexahydrate; calcium chloride; dihydrate and potassium chloride. The first solution will further include a base effective to adjust the pH to above 7, preferably from 7.3 to 8. One acceptable base is sodium hydroxide. The solution is formed by simply blending the components together in water in an oxygen-containing environment, and storing the formed solution in a container.

The second solution will include water and reduced glutathione at a pH below 7, preferably a pH of from about 3 to about 6. This solution will be substantially free of dissolved oxygen. Generally, this means that there is insufficient oxygen present to have a deleterious effect on the glutathione.

This solution is formed by blending the reduced glutathione with water and an effective amount of a base to establish the desired pH of below 7 and preferably about 3-6. This solution is then purged with an inert gas, such as nitrogen or argon, to drive out any dissolved oxygen. If the pH of Solution A is 8.0 the pH of Solution B will be about 3.0. If the pH of Solution A is 7.8 the pH of Solution B will be about 4.0. And, if the pH of Solution A is 7.6 the pH of Solution B will be about 5.0.

The second solution can also include one or more dissolved salts if desired.

The relative concentrations of all the components of the present invention are established to achieve a tissue preservation solution, as is well known in the art, and is further explained in the detailed examples. The tissue preservation system of the present invention is used by simply combining the two solutions in desired amounts at the point of use. The solution is then used to preserve tissue or organs.

The solutions, devices, and perfusion methods of the present invention are not limited to use with a particular tissue, organ or cell type. For example, the invention may be used with harvested saphenous veins, epigastric arteries, gastroepiploic arteries and radial arteries used in coronary bypass grafting (CABG). The present invention may also be used to maintain organs and tissue during transplant operations. The present invention is not limited to any particular tissue or organ. For example, it is contemplated that such organs or tissues may be heart, lungs, kidney, brain, muscle grafts, skin, intestine, bone, appendages, eyes, etc or portions thereof. Additionally, the present invention may be used as an in situ tissue or organ preservative. It is contemplated that the solution of the present invention be used to wash and bath tissues and organs that have not been removed from the patient. For example, it is contemplated that the present invention be used during cardioplegia. It is also contemplated that the present invention be used in, for example, emergency procedures where a tissue or organ may need to be bathed to preserve it until surgery or other medical attention can be obtained. In this regard, the solution may be made available to emergency medical personnel both in hospital settings and “in the field” (i.e., in ambulances or in temporary emergency medical facilities).

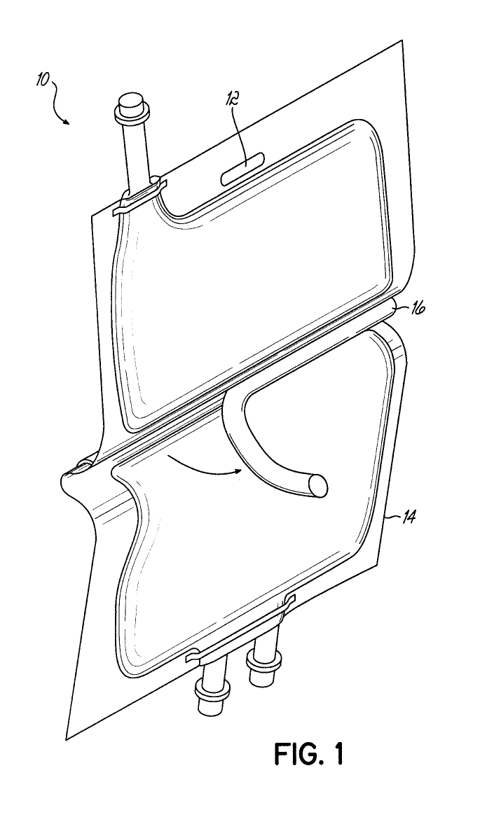

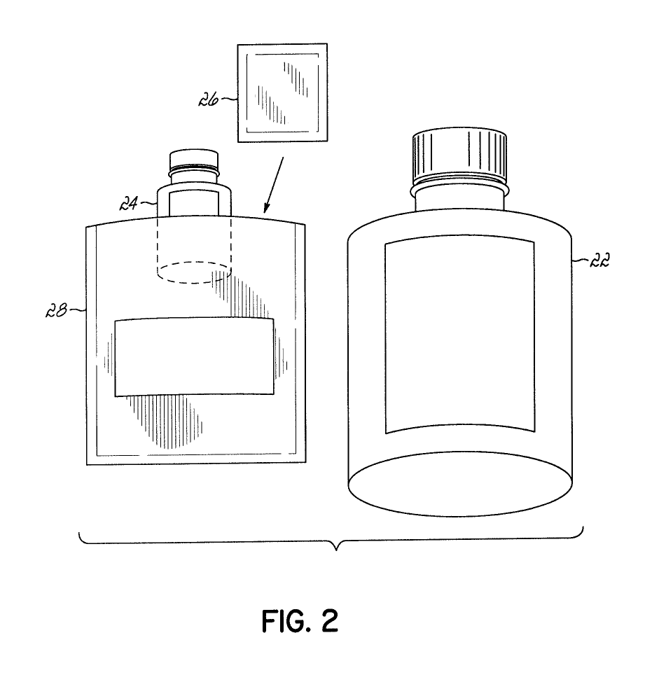

Kits can be formed according to the present invention. The first and second solutions can be placed in separate chambers of one container such as the bag shown in FIG. 1 forming a kit. Alternatively, the first and second solutions can be placed in separate containers as shown in FIG. 2.

FIG. 1 shows a bag 10 having two chambers 12 and 14 that are partitioned or clamped off from each other by clamp 16. Chamber 12 contains a first solution and chamber 14 contains a second solution. When clamp 16 is removed, chambers 12 and 14 become one chamber of bag 10 and Formulation A mixes with Formulation B resulting in the complete organ and tissue preservation solution in bag 10. See U.S. Pat. No. 5,257,985, the disclosure of which is hereby incorporated herein by reference.

FIG. 2 shows an organ and tissue preservation kit 20 having two containers 22 and 24. A first solution is contained in container 22 and a second solution is contained in container 24. At the point of use, the contents of container 24 can be emptied into container 22 to produce the complete organ and tissue preservation solution.

The following examples are meant to illustrate the invention, but not limit it in any way.

### Example 1

Tissue Preservation Formulation having Increased Stability and Shelf Life.
Embodiment 1

| | |
|---|---|
| Component | Concentration g/L |

Formulation A

| Mannitol | 10.930 | |
|---|---|---|
| Lactobionic acid | 28.664 | |
| Glutamic acid | 2.942 | |
| Magnesium chloride hexahydrate | 2.642 | |
| Calcium chloride dihydrate | 0.037 | g |
| Potassium chloride | 1.18 | g |
| Histidine | 4.650 | g |

| | |
|---|---|
| Sodium Hydroxide | |
| Sodium Hydroxide 4% | Adjust pH to 7.3 to 8.3 |
| Water for injection (WFI) | q.s. to 950 ml |

Formulation B in inert atmosphere in which Oxygen has been removed

| | |
|---|---|
| Glutathione reduced | 0.922 |
| WFI | q.s. 50 ml |
| NaOH | adjust pH to 4.0-6.0 |

### Example 2

Embodiment 2 (Free radical quenchers added to solution B)

| | |
|---|---|
| Component | Concentration g/L |

Formulation A

| Mannitol | 5.930 | |
|---|---|---|
| Lactobionic acid | 28.664 | |
| Glutamic acid | 2.942 | |
| Magnesium chloride hexahydrate | 2.642 | |
| Calcium chloride dihydrate | 0.037 | g |
| Potassium chloride | 1.18 | g |
| Histidine | 3.650 | g |
| Sodium Hydroxide | 4.0 | g |

| | |
|---|---|
| Sodium Hydroxide 4% | Adjust pH to 7.8 |
| Water for injection | q.s. to 950 ml |

Formulation B in inert atmosphere

| | |
|---|---|
| Glutathione reduced | 0.922 |
| Mannitol | 5.0 |
| Histidine | 1.0 |
| WFI | q.s. 50 ml |
| NaOH | adjust pH to 6.0 |

### Example 3

Formula 2 alternative (No potassium formula)

| | |
|---|---|
| Component | Concentration g/L |

Solution A

| Mannitol | 5.930 | |
|---|---|---|
| Lactobionic acid | 28.664 | |
| Glutamic acid | 2.942 | |
| Magnesium chloride hexahydrate | 2.642 | |
| Calcium chloride dihydrate | 0.037 | g |
| Sodium chloride | 0.88 | g |
| Histidine | 3.650 | g |
| Sodium Hydroxide | 4.00 | g |

| | |
|---|---|
| Sodium Hydroxide 4% | Adjust pH to 7.3 |
| Water for injection | q.s. to 950 ml |

Solution B

| | |
|---|---|
| Glutathione reduced | 0.922 |
| Mannitol | 5.0 |
| Histidine | 1.0 |
| WFI | q.s. 50 ml |
| NaOH | adjust pH to 6.0 |

As indicated, the kit is used by combining solution A with solution B at the point of use. The formed blend is immediately ready to use as an organ preservation solution. It should also be noted that the kit can be made up of three separate solutions if desired.

What is claimed is:

1. An organ and preservation kit comprised of a first aqueous solution contained in a first container and a second solution contained in a second container wherein the first aqueous solution comprises one or more salts, water, dissolved oxygen, lactobionic acid and glutamic acid and said first solution has a pH of at least 7.0; and wherein the second solution comprises water, reduced glutathione and said second solution has a pH of below 7 and wherein the second solution is substantially free of oxygen.

2. The kit of claim 1 wherein the first and second containers are first and second chambers contained within a single container and the first and second chambers are partitioned off from each other by a partition, wherein upon the removal of the partition, the first solution mixes with the second solution to form the complete organ and tissue preservation solution.

3. The kit of claim 1 wherein the pH of the first solution is about from about 7.3 to about 8.3 and the pH of the second solution is from about 4 to about 6.

4. The kit of claim 1 wherein the second solution further comprises mannitol and histidine.

5. A method for preparing an organ or tissue preservation solution comprising;
combining a first solution comprising water, one or more salts, lactobionic acid and glutamic acid wherein the solution contains dissolved oxygen and has a pH of above 7;
with a second solution comprising water and glutathione together at a pH of below 7 wherein said second solution is substantially free of oxygen;
wherein the first solution is combined with the second solution at the point of use.

6. The process of claim 5 wherein said second solution further comprises mannitol and histidine.

7. The process of claim 5 wherein the pH of the first solution is from about 7.3 to 8.3 and the pH of the second solution is about from 3 to 6.

8. A method for preserving a tissue or organ comprised of bringing the tissue or organ into contact with a solution made according to the process of claim 5.

9. The method of claim 8 wherein the tissue or organ is selected from the group consisting of saphenous veins, epigastric arteries, gastroepiploic arteries, radial arteries, heart, lungs, kidney, brain, muscle grafts, skin, intestine, bone, appendages, eyes, and portions of said tissue or organs.
